(19) United States
(12) Patent Application Publication
(10) Pub. No.: US 2022/0242718 A1
(43) Pub. Date: Aug. 4, 2022

(54) A Beverage Dispensing System

(71) Applicant: Kieran SHAMS-ABBECKAH, Dorset (GB)

(72) Inventor: Kieran SHAMS-ABBECKAH, Dorset (GB)

(21) Appl. No.: 17/619,241

(22) PCT Filed: Jul. 23, 2020
(86) PCT No.: PCT/IB20/56964

§ 371 Date: Dec. 14, 2021

(30) Foreign Application Priority Data
Jul. 30, 2019 (GB) 1910822.4

(51) Int. Cl. B67D 3/00; B67D 1/08; H04W 4/80

(52) U.S. Cl. CPC B67D 3/0032; B67D 1/0875; B67D 3/0003; B67D 2210/00089; B67D 3/0077; B67D 3/0083; H04W 4/80; B67D 3/0041

(57) ABSTRACT

A beverage dispensing system includes at least one bottle attachment portion, each having a first end providing a first attachment feature releasably engages a spout of a bottle; and an opposed second end providing a second attachment feature, in which a fluid passageway extends between the first end and the second end of the bottle attachment portion. A housing includes an upper surface defining at least one recess, each providing a housing attachment feature releasably engages the second attachment feature of a corresponding bottle attachment portion, each recess comprising an opening enabling fluid to pass therethrough; a support surface supports a receptacle thereon; and an actuator initiates dispensing of fluid from a bottle via the fluid passageway, through the opening of a recess, and into a receptacle supported on the support surface. An LED illuminates a portion of a bottle supported by or within the housing.

### FIELD OF THE INVENTION

The present invention relates to a beverage dispensing system. More particularly, but not exclusively, the invention relates to an illuminated beverage dispensing system for improving accuracy and speed of dispensing a beverage.

### BACKGROUND

A bartender conventionally dispenses drink from a bottle into a glass by pouring. A spout may be attached to the free end of a spout of a bottle to ensure that liquid is dispensed at a constant flow rate to aid ease of pouring without use of a measuring device. It is however difficult to ensure that an exact amount of liquid is poured into a drink when poured by hand. As a result, beverage dispensing systems are used in bars and restaurants.

At points of sale, where bars are busy and crowded, it is important to serve customers promptly to enable them to move away from a bar area as soon as possible.

### PRIOR ART

US patent application US 2017/0081166 (BBF Creation LLC) discloses a bottle dispenser with a housing in the form of a large bottle. The housing defines an outer reservoir. An inner reservoir is provided in the housing. The inner reservoir is filled with an alcoholic beverage. The outer reservoir does not contain an alcoholic beverage. An illumination means within the dispenser illuminates the inner reservoir.

US patent application US 2014/0263418 (BERG Company LLC) discloses a system for dispensing a beverage from a bottle. The system includes a pour spout, a server and a control unit that communicates a message from a control unit to at least one of a server interface carried by a beverage server and a pour spout secured to a bottle.

The message includes or initiates a dispensing command, wherein the pour spout responds to the dispensing command by opening a spout valve through which a beverage flows from the bottle via the pour spout.

US patent application US 2013/0233438 (Jimroglou et al) discloses a leak-proof drink dispensing system. The system includes a container, a spigot, and a lid adapted to fit a correspondingly sized cup. The spigot extends from an outside portion of the container, and comprises a lever, cylindrical nozzle, and threaded cylindrical locking collar. The lid has a threaded cylindrical spout that is connected to the spigot, such that rotation of the lever causes the threads of the collar to engage with threads of the spigot. This causes the lid to become releasably affixed to the spigot for purposes of leak-free dispensing of the liquid from the container.

Published International patent application WO-A2-2018/055643 (Akshet) discloses an automated beverage dispensing system for dispensing a beverage made from one or more ingredients. The system may be arranged to move a beverage cup between a plurality of dispensing stations so that one or more beverage ingredients may be dispensed into the cup at each dispensing station.

Another type of cocktail maker is disclosed in a YouTube® video which shows a device which is sold under the trade mark BARSYS—operating to mix and dispense drinks automatically https://www.youtube.com/watch?v=08wSMKKdSB8.

The present invention arose in order to provide an improved beverage dispensing system which overcomes problems suffered by existing systems.

Another object of the invention is to provide an automatic beverage dispensing system that is able to provide an automated drinks dispensing at a station, for example for use in a crowded bar or where social distancing is required.

A further aim of the invention is to provide an automatic beverage dispensing system that is able to dispense an automated drink that is able to dispense drinks of differing viscosities to a very high degree of precision.

Another object of the present invention is to provide a beverage dispensing system that is able to be used with a wide range of soft drinks and alcoholic drinks and which enables drinks to be dispensed at an optimum speed in accordance with a characteristic of the beverage, for example the viscosity of the beverage.

### SUMMARY OF THE INVENTION

According to a first aspect of the present invention there is provided a beverage dispensing system comprising:

at least one bottle attachment portion, each bottle attachment portion comprising a first end with a first attachment feature configured to releasably engage a spout of a bottle; and an opposed second end which provides a second attachment feature and a fluid passageway extends between the first end and the second end of the bottle attachment portion;
a housing which includes an upper surface defining at least one recess, each recess provides a housing attachment feature configured to releasably engage the second attachment feature of a corresponding bottle attachment portion, each recess comprising an opening enabling fluid to pass therethrough;
a support surface configured to support a drinks vessel thereon; and
an actuator is configured to initiate dispensing of a beverage, stored in a bottle, via the fluid passageway into the drinks vessel; characterised in that a control means receives a command signal and is operative to select a volume of at least one beverage to be dispensed.

Ideally the control means receives the command signal via a keypad. In some embodiments the control means receives the command signal via a wireless receiver, the signal having been transmitted from a wireless transmitter in a mobile communication device. An example of a wireless transmitter is a transmitter operating in accordance with Bluetooth® protocol in a smartphone

Ideally the smartphone has application specific software (APP) operative thereon which presents a user with a menu for selecting a user defined combination of drinks and when selected transmits the command signal.

Ideally at least one LED configured in use to illuminate a portion of a bottle supported by or within the housing.

The or each bottle attachment portion preferably comprises at least one LED configured in use to illuminate a bottle releasably engaged thereto.

A variable dispensing means enables a user selectable amount of beverage to be dispensed.

Ideally a speed controller is provided to vary the speed of flow of the beverage. A means may be included in order to vary the flow in dependence upon the viscosity of the beverage being dispensed.

A sensor or calibration system may be provided in order to sense the viscosity of beverage to be dispensed and to modify a pump speed and/or pumping duration. Optionally a calibration dial is provided which also displays if a sensor is faulty, so that the user is able to manually fine-tune a pump speed and/or pumping duration.

In one embodiment, the first end of the, or each, bottle attachment portion preferably comprises at least one light emitting diode (LED) is configured in use to illuminate a bottle releasably engaged thereto. For example, the first attachment feature of the bottle attachment portion preferably comprises the at least one LED.

In one embodiment, the housing preferably comprises at least one LED configured in use to illuminate a bottle releasably engaged thereto. The LEDs may be located on any particular location on the housing.

In one embodiment, the housing further comprises at least one bottle support portion configured in use to be located adjacent and/or abut a base of a bottle. The bottle support portion may be positioned adjacent and spaced apart from an upper surface of the housing. In one embodiment the, or each, bottle support portion may be aligned with and spaced apart from a corresponding recess of the housing.

In one embodiment the, or each, bottle support portion further comprises at least one LED configured in use to illuminate a base portion of a bottle releasably engaged to the housing.

In one embodiment, the support surface of the housing comprises at least one LED configured in use to illuminate a receptacle positioned thereon.

The system is preferably self-contained and portable and ideally dimensioned to sit atop a cabinet or table so as to be able to be used in a house or bar. Optionally a wall rack is provided in order to enable the system to be mounted on a wall.

The system may comprise any suitable number of recesses and/or bottle support portions, depending on its particular requirements.

The actuator may be manually controlled or automatic and is optionally adapted to be controlled by a remote device such as a mobile electronic communication device, for example a hand held device or a smartphone suitably modified. Such an arrangement permits users to tailor a drink to suit their individual tastes.

In one embodiment drinks may be depicted on a displayed of the hand held device and optionally a menu is presented to a user in order to enable a user to select a specific mixture of drink and to transmit instructions on the beverages required and how to prepare that drink to. As this data is pre-set it is also envisaged that a user may send and receive to one another drinks mixtures and ingredients from pre-defined menus.

The actuator is automated and ideally configured on operation to dispense a predetermined volume of liquid from a bottle, such as for example 25 ml. A user may activate the actuator by a single operation (for example push) of the actuator to dispense a single set volume of liquid or the actuator may be activated by way of a pump or other device. A user may activate the actuator using multiple commands, for example to dispense a double measure of an alcoholic beverage.

Advantageously at least one bottle attachment portion comprises a first end providing a first attachment feature configured to releasably engage a spout of a bottle; and an opposed second end providing a second attachment feature, in which a fluid passageway extends between the first end and the second end of the bottle attachment portion, in which at least one LED is located at or adjacent the first end thereof, in which the at least one LED is configured in use to illuminate at least a portion of a bottle releasably engaged thereto.

The bottle attachment portion may comprise an optic bottle insert located at or adjacent the first end thereof. The optic bottle insert preferably extends outwardly from the first end of the bottle attachment portion. The optic bottle insert may have any suitable shape. In one embodiment, the optic bottle insert is substantially elongate in shape.

It is however to be understood that the optic bottle insert may be curved, helical or form a predetermined shape depending on the particular requirements for the portion.

The bottle attachment portion preferably comprises a bayonet mechanism located at or adjacent the second end thereof.

The bottle attachment portion further comprises an air passageway extending from the first end thereof towards an outlet. The outlet may be provided in any suitable location on the bottle attachment portion, such as for example towards the second end thereof.

The system preferably further comprises a power supply. The power supply may be mains power or a battery pack.

According to a further aspect of the invention there is provided distributed bar comprises a plurality of beverage dispensing systems as claimed in any preceding claim which are connected to a central controller or server, the central controller or server is operative to communicate with a plurality of remote wireless devices, thereby enabling customers to place a drinks order and the central controller or server to indicate to each wireless device, the location of the beverage dispensing system from where to collect a drink once payment is received.

A preferred embodiment of the invention will now be described by way of example only and with reference to the Figures in which:

### BRIEF DESCRIPTION OF FIGURES

FIG. 1 shows a schematic illustration of a perspective view from above of the beverage dispensing system according to one embodiment of the present invention;

FIG. 2 shows a schematic illustration of a perspective view from below of the beverage dispensing system of FIG. 1;

FIG. 3 shows a schematic illustration of an exploded view of the beverage dispensing system of FIG. 1;

FIG. 4 shows a schematic illustration of a perspective view from above of the bottle attachment portion according to one embodiment of the present invention;

FIG. 5 shows a schematic illustration of a perspective view from below of the bottle attachment portion of FIG. 4;

FIG. 6 shows a schematic illustration of an exploded view of the bottle attachment portion of FIG. 4;

FIG. 7 is a diagrammatical representation of valve system which is part of a remote control means; and

FIG. 8 is a diagrammatical overview of an example of the system operating with a remote wireless device that provides a user a menu of drinks options.

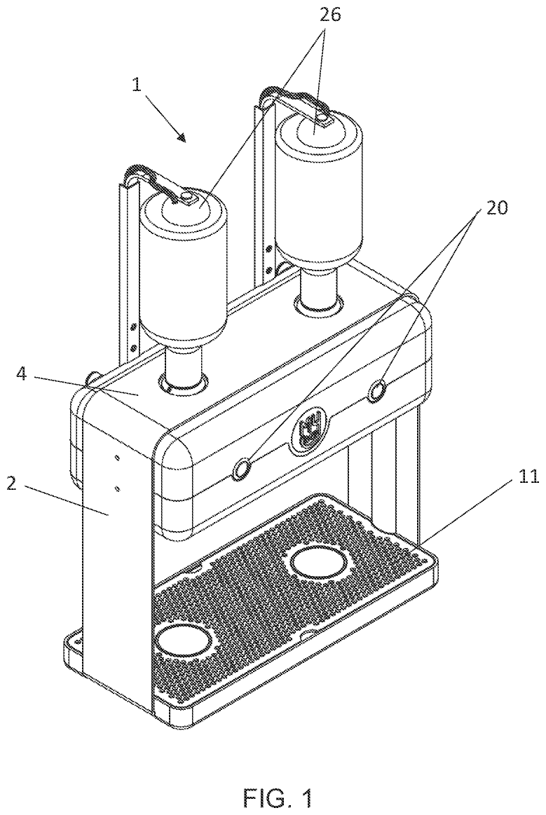

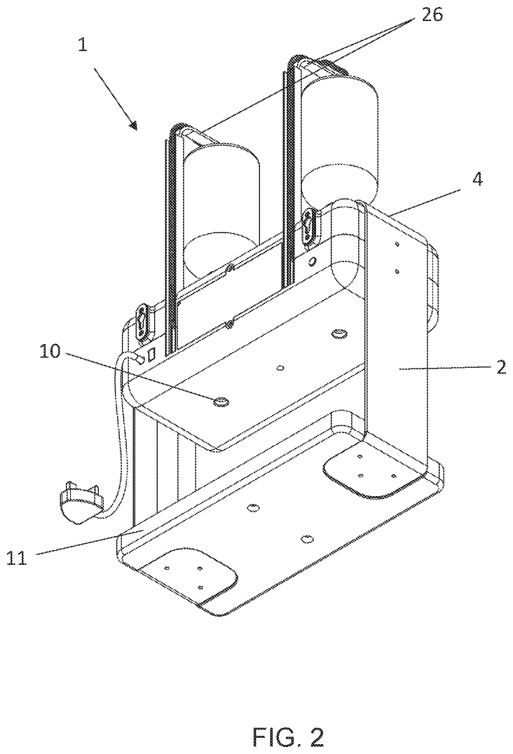

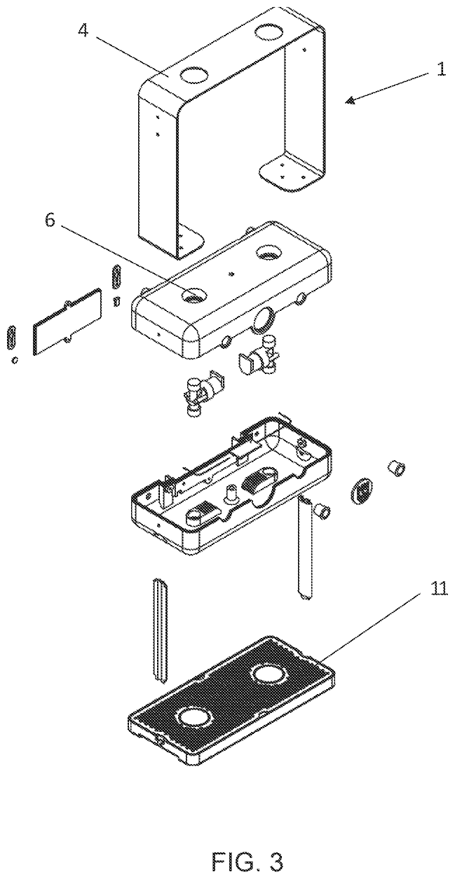

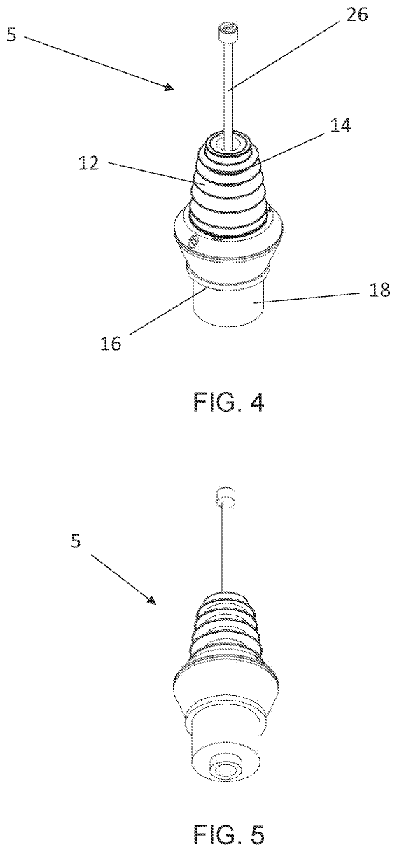

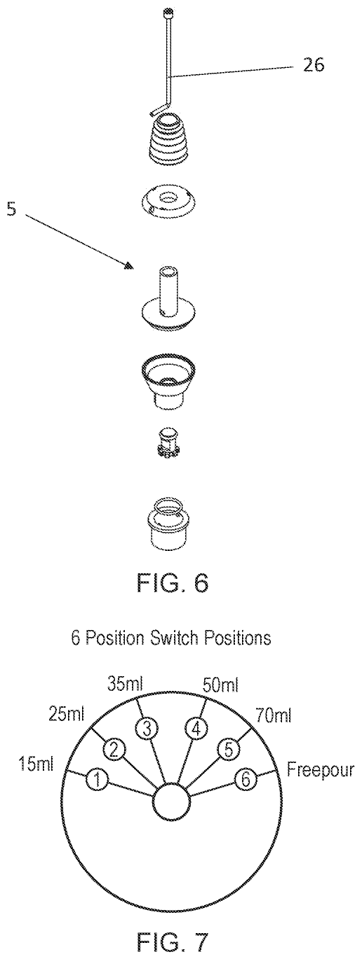

### DETAILED DESCRIPTION OF A PREFERRED EMBODIMENT OF THE INVENTION

With reference to the Figures, the beverage dispensing system 1 a housing 2 comprising an upper surface 4 defining two spaced apart recesses 6. Each recess 6 providing a housing attachment feature 8 configured to releasably engage a corresponding bottle attachment portion 5. Each recess 6 comprises an opening 10 enabling fluid to pass therethrough.

Each bottle attachment portion 5 comprising a first end 12 providing a first attachment feature 14 configured to releasably engage a spout of a bottle; and an opposed second end 16 providing a second attachment feature 18 for releasably engaging the housing attachment feature 8. A fluid passageway extends between the first end 12 and the second end 14 of the bottle attachment portion 5.

The beverage dispensing system 1 further comprises a support surface 11 configured to support a receptacle (not shown). The receptacle is generally a glass, for example a shot glass.

The beverage dispensing system further comprises an actuator 20 configured to initiate dispensing of fluid from a bottle (not shown) through the opening of a recess 6, and into a receptacle supported on the support surface 11. The actuator 20 is a push-button configured to dispense a predetermined volume of fluid on actuation, such as for example 25 ml. Continued pressure on the actuator 20 can enable fluid to free flow from the bottle to the receptacle.

The beverage dispensing system 1 further comprises LEDs configured in use to illuminate a portion of a bottle supported by or within the housing. The LEDs may be provided in any suitable location on the housing and/or bottle attachment portion 5.

Preferably, the or each bottle attachment portion 5 comprises at least one LED configured in use to illuminate a bottle releasably engaged thereto. The first end 12 of the, or each, bottle attachment portion 5 preferably comprises at least one LED configured in use to illuminate a bottle releasably engaged thereto.

In the illustrated embodiment, the bottle attachment portion 5 comprises an optic bottle insert 24 comprising at least one LED located at or adjacent the first end 12 thereof. The optic bottle insert 24 is substantially elongate in shape and substantially centrally located.

The housing 2 further comprises at least one bottle support portion 26 configured in use to be located adjacent and/or abut a base of a bottle. The, or each, bottle support portion 26 is aligned with and spaced apart from a corresponding recess 6 of the housing 2. The or each bottle support portion 26 further comprises at least one LED configured in use to illuminate a base portion of a bottle releasably engaged to the housing 2.

The support surface 11 of the housing 2 comprises at least one LED configured in use to illuminate a receptacle positioned thereon.

In use, the first attachment feature 14 of the first end 12 of a bottle attachment portion 5. The optic bottle insert 24 is received within the spout of the bottle. The bottle is then inverted and the second attachment feature 18 at the second end 16 is releasably engaged with the housing attachment feature 8 of the housing 2.

The LEDs of the support surface 11, the bottle support portion 26 and the optic bottle insert 24 are switch on and illuminate the adjacent surfaces and bottle.

The user operates the actuator 20 when required to efficiently and accurately dispense fluid from the bottle with the bayonet mechanism to the receptacle.

Referring briefly to FIG. 7 there is shown a dispenser 700 with a 6 position dial 702 which controls how much liquid is dispensed. An illumination means, such as an LED 704 is

Light under corresponding glass which light up according to which switch is pressed, and what position the dial is in:
Orange—15 ml
Yellow—25 ml
Green—35 ml
Red—50 ml
Purple—70 ml
Blue—Free-pour

Optionally a DC port and a power rocker switch are provided on a side of the device. The DC port enables power to be provided from a supply (not shown) and the rocker switch enables the device to be switched on and off manually.

Optionally a timing system which is controlled by a microprocessor enables a standby mode to be when the device is not in use for a certain period of time it will switch to a power saving mode.

The control system includes a means for measuring viscosity of a beverage to be dispensed and a processor that determines a pump speed and/or pump pressure, so that beverages are dispensed at a correct speed, thereby ensuring a correct amount of liquid has been precisely dispensed.

A removable drip tray (not shown) enables any spilled liquids to be collected. A switch may be provided which immobilises the system in the event that a predefined depth of liquid is reached in the tray so as to avoid spillage from the tray.

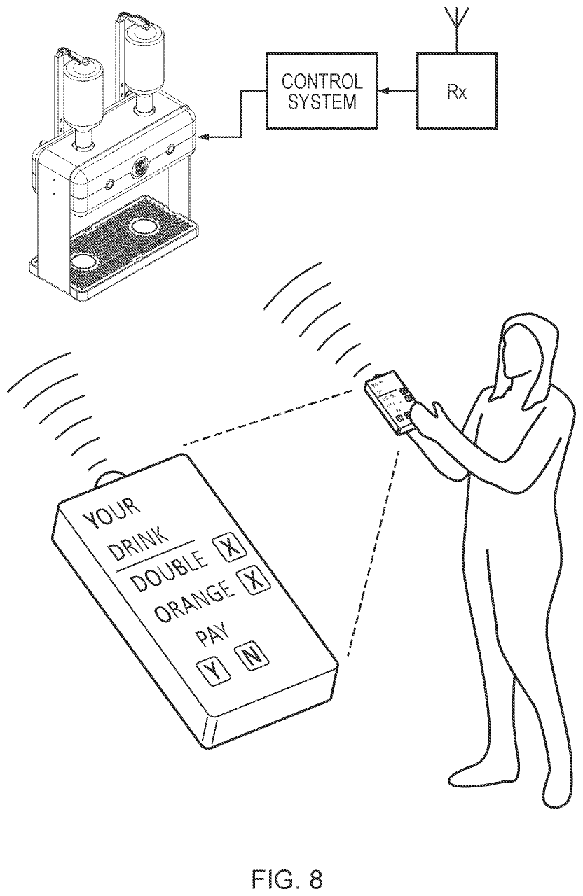

FIG. 8 shows a drinks dispensing system of the type described above, to which is connected a receiver, which is ideally a wireless receiver. The wireless receiver is connected to a control system which may be housed in the drinks dispensing system.

Commands can be sent to the receiver from a user's smartphone or a remote control device in order to place an order for a drink. One location where such multi-dispensing systems may be provided is at theatres, where there is often a very busy period of dispensing and serving drinks, during a relatively short interval. Therefore being able to pre-order and have drinks prepared is considered to save time and reduce the burden placed on bar staff and improve productivity and thereby improve a customer's experience as well as increase profit to the theatre.

It is also appreciated that several such systems could be provided at different locations, particularly in larger halls and auditoriums of cinemas and theatres. Each system is ideally configured to supply one or two or three drink types or mixtures. An advantage of this is that customers are able to select the drink they require, prior to an interval, and to go and receive their selected drink at a specified location. Such a distributed drinks system reduces crowding at a bar and ensures people queue at the location where their drink is delivered and supplied, which helps to ensure drinks are dispensed where and when required.

In such a distributed system, where different dispensers are placed at different locations, a customer may receiver a message from a central server or a main controller, indicating from where their drink(s) is/are to be collected, so that the customer can proceed directly to that location ensuring minimum delay and wait time.

Optionally a payment device, such as contactless card payment device, or customer ID verification means, is provided at each location in order to accept payment or to receive a code or some other form of point of sale verification, so that drinks are provided only to customers who have already pre-ordered and paid, thereby ensuring that only bona fide customers receive their drink.

The invention has been described by way of examples only and it will be appreciated that variation may be made to the above-mentioned embodiments without departing from the scope of invention as defined by the claims.

1. A beverage dispensing system comprising:
at least one bottle attachment portion, each bottle attachment portion comprising a first end with a first attachment feature configured to releasably engage a spout of a bottle; and an opposed second end which provides a second attachment feature and a fluid passageway extends between the first end and the second end of the bottle attachment portion;
a housing which includes an upper surface defining at least one recess, each recess provides a housing attachment feature configured to releasably engage the second attachment feature of a corresponding bottle attachment portion, each recess comprising an opening enabling fluid to pass therethrough;
a support surface configured to support a drinks vessel thereon; and
an actuator is configured to initiate dispensing of a beverage, stored in a bottle, via the fluid passageway into the drinks vessel; wherein
control means receives a command signal and is operative to select a volume of at least one beverage to be dispensed; and
the at least one bottle attachment portion comprises at least one LED which is configured in use to illuminate a portion of a bottle when releasably engaged to the bottle attachment portion.

2. The beverage dispensing system as claimed in claim 1, wherein the control means receives the command signal via a keypad.

3. The beverage dispensing system as claimed in claim 1, wherein the control means receives the command signal via a wireless receiver, the signal having been transmitted from a wireless transmitter in a mobile communication device.

4. The beverage dispensing system as claimed in claim 3, wherein the wireless transmitter is a transmitter operating in accordance with BLUETOOTH® protocol in a smartphone.

5. The beverage dispensing system as claimed in claim 4, wherein the smartphone has application specific software (APP) which is operative to present a user with a menu for selecting a user defined combination of drinks and when selected transmits the command signal.

6. (canceled)

7. The beverage dispensing system as claimed in claim 1 wherein the, or each, bottle attachment portion comprises at least one LED configured in use to illuminate a bottle releasably engaged thereto.

8. (canceled)

9. The beverage dispensing system as claimed in claim 7, in which the first attachment feature of the bottle attachment portion comprises the at least one LED.

10. The beverage dispensing system as claimed in claim 7, in which the housing comprises at least one LED configured in use to illuminate a bottle releasably engaged thereto.

11. The beverage dispensing system as claimed in claim 10, in which the housing further comprises at least one bottle support portion configured in use to be located adjacent and/or abut a base of a bottle.

12. The beverage dispensing system as claimed in claim 11, in which the or each bottle support portion is aligned with and spaced apart from a corresponding recess of the housing.

13. The beverage dispensing system as claimed in claim 12, in which the or each bottle support portion further comprises at least one LED configured in use to illuminate a base portion of a bottle releasably engaged to the housing.

14. The beverage dispensing system as claimed in claim 1, in which the support surface of the housing comprises at least one LED configured in use to illuminate a receptacle positioned thereon.

15. The beverage dispensing system as claimed in claim 1 includes a payment terminal.

16. The beverage dispensing system as claimed in claim 15 wherein the payment terminal includes a contactless payment terminal.

17. The distributed bar comprises a plurality of beverage dispensing systems as claimed in claim 1 which are connected to a central controller or server, the central controller or server is operative to communicate with a plurality of remote wireless devices, thereby enabling customers to place a drinks order and the central controller or server to indicate to each wireless device, the location of the beverage dispensing system from where to collect a drink once payment is received.

18. The distributed bar as claimed in claim 17 wherein the central controller or server is operative to communicate a payment receipt and a location of the beverage dispensing system to each wireless device upon receipt of funds from a customer.

19. A bottle attachment portion comprising
a first end providing a first attachment feature configured to releasably engage a spout of a bottle; and
an opposed second end providing a second attachment feature, in which a fluid passageway extends between the first end and the second end of the bottle attachment portion, in which at least one LED is located at or adjacent the first end thereof, in which the at least one LED is configured in use to illuminate at least a portion of a bottle releasably engaged thereto.

20. The bottle attachment portion as claimed in claim 19, in which the portion comprises an optic bottle insert located at or adjacent the first end thereof.

21. The bottle attachment portion as claimed in claim 20, in which the optic bottle insert extends outwardly from the first end of the bottle attachment portion.

22. The bottle attachment portion as claimed in claim 21, in which the optic bottle insert is substantially elongate in shape.

23. The bottle attachment portion as claimed in claim 19, further comprising a bayonet mechanism located at or adjacent the second end thereof.
